(19) United States
(12) Patent Application Publication
(10) Pub. No.: US 2026/0245366 A1
(43) Pub. Date: Aug. 20, 2026

(54) INFORMATION PROCESSING

(71) Applicants: Beijing Zitiao Network Technology Co., Ltd., Beijing (CN); Bytedance Technology Ltd., Grand Cayman (KY)

(72) Inventors: Xiaobin ZHUANG, Beijing (CN); Zhuo CHEN, Los Angeles, CA (US); Yuping WANG, Beijing (CN); Yuxuan WANG, Los Angeles, CA (US)

(21) Appl. No.: 19/540,455

(22) Filed: Feb. 13, 2026

(30) Foreign Application Priority Data
Feb. 18, 2025 (CN) 202510179760.1

(51) Int. Cl. G06V 20/40; G06F 16/683

(52) U.S. Cl. CPC G06V 20/46; G06F 16/683

(57) ABSTRACT

Embodiments of the disclosure relate to a method, an apparatus, a device, and a storage medium for information processing. The method proposed herein includes: processing video content using an action encoder to determine an action feature, and processing the video content using an image encoder to determine an image feature; constructing an input feature of a model based on the action feature, the image feature, and an audio feature of audio content; and providing the input feature to the model to determine a matching degree between the video content and the audio content. Accordingly, the embodiments of the disclosure can evaluate the matching degree between the video content and the audio content from multiple perspectives based on images and actions of the video content and the audio content, thereby improving the accuracy of the matching degree between the video content and the audio content.

### CROSS-REFERENCE

The present application claims priority to Chinese Patent Application No. 202510179760.1, filed on Feb. 18, 2025 and entitled “METHOD, APPARATUS, DEVICE AND MEDIUM FOR INFORMATION PROCESSING”, the entirety of which is incorporated herein by reference.

### FIELD

Example embodiments of the present disclosure generally relate to the field of computers, and in particular, to information processing.

### BACKGROUND

In recent years, with the rapid development of video technologies, more and more video works have been presented in people's lives. For example, such video works are widely produced in various fields such as video production, game development, film post-production, and multimedia interactive systems. In order to improve the effect of a video work, the video work usually includes various appropriate sound effects. The precise matching of sound effects with images may significantly improve the quality of the work and the immersion of the audience. Therefore, how to more accurately evaluate the matching degree between audio and video has become a focus of attention.

### SUMMARY

In a first aspect of the present disclosure, a method of information processing is provided. The method includes: processing, using an action encoder, video content to determine an action feature, and processing, using an image encoder, the video content to determine an image feature; constructing an input feature of a model based on the action feature, the image feature, and an audio feature of audio content; and providing the input feature to the model to determine a matching degree between the video content and the audio content.

In a second aspect of the present disclosure, an apparatus for information processing is provided. The apparatus includes: a first determining module configured to process, using an action encoder, video content to determine an action feature, and process, using an image encoder, the video content to determine an image feature; a constructing module configured to construct an input feature of a model based on the action feature, the image feature, and an audio feature of audio content; and a second determining module configured to provide the input feature to the model to determine a matching degree between the video content and the audio content.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium has a computer program stored thereon which is executable by a processor to implement the method of the first aspect.

It would be appreciated that the content described in the Summary section of the present disclosure is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference numerals refer to the same or similar elements, where:

FIG. 1 shows a schematic diagram of an example environment in which the embodiments according to the present disclosure may be implemented;

FIG. 2 shows a flowchart of an example process of evaluating a matching degree between audio content and video content according to some embodiments of the present disclosure;

FIG. 3 shows a flowchart of an example process of information processing according to some embodiments of the present disclosure;

FIG. 4 shows a schematic structural block diagram of an example apparatus for information processing according to some embodiments of the present disclosure; and

FIG. 5 shows a block diagram of an electronic device capable of implementing multiple embodiments of the present disclosure.

### DETAILED DESCRIPTION

The embodiments of the present disclosure will be described in more detail below with reference to the drawings. Although some embodiments of the present disclosure are shown in the drawings, it would be appreciated that the present disclosure may be implemented in various forms and should not be construed as limited to the embodiments set forth herein. Instead, these embodiments are provided for a more thorough and complete understanding of the present disclosure. It would be appreciated that the drawings and embodiments of the present disclosure are only for illustrative purposes and are not intended to limit the protection scope of the present disclosure.

It should be noted that the titles of any section/subsection provided herein are not restrictive. Various embodiments are described throughout this article, and any type of embodiment may be included under any section/subsection. Furthermore, the embodiments described in any section/subsection may be combined with any other embodiments described in the same section/subsection and/or different section/subsection in any manner.

In the description of the embodiments of the present disclosure, the term "comprise" and similar terms thereof should be understood as open-ended inclusions, that is, "comprise but not limited to". The term "based on" should be understood as "at least partially based on". The term "one embodiment" or "the embodiment" should be understood as "at least one embodiment". The term "some embodiments" should be understood as "at least some embodiments". Other explicit and implicit definitions may also be included below. The terms "first", "second", etc. may refer to different or same objects. Other explicit and implicit definitions may also be included below.

The embodiments of the present disclosure may involve user's data, acquisition and/or use of data, etc. These aspects all comply with corresponding laws, regulations and related provisions. In the embodiments of the present disclosure, all data collection, acquisition, processing, machining, forwarding, use, etc. are carried out on the premise that the user knows and confirms. Accordingly, when implementing the embodiments of the present disclosure, the user should be informed of the type, range of use, use scenarios, etc. of the data or information that may be involved and obtain the user's authorization in an appropriate manner in accordance with relevant laws and regulations. The specific manner of informing and/or authorizing may vary according to the actual situation and application scenarios, and the scope of the present disclosure is not limited in this regard.

If the solutions in the specification and embodiments involve personal information processing, the processing will be carried out on the premise that there is a legal basis (for example, the consent of the personal information subject is obtained, or it is necessary to perform a contract, etc.), and the processing will only be carried out within the scope of regulations or agreements. If a user refuses to process personal information other than the necessary information required for the basic functions, it will not affect the user's use of the basic functions.

As mentioned above, the precise matching of sound effects with images can significantly improve the quality of a work and the immersion of an audience. In traditional technologies, feature extraction is performed on sound effects and images respectively to evaluate the matching degree between the sound effects and images. However, such an evaluation method can only evaluate the semantic matching degree between the sound effects and the images globally, and cannot evaluate whether the details between the sound effects and the images match. Therefore, it is difficult for such an evaluation method to accurately evaluate the matching degree between the sound effects and the images.

The embodiments of the present disclosure provide a solution for information processing. According to the solution, video content may be processed using an action encoder to determine an action feature, and the video content may be processed using an image encoder to determine an image feature. Furthermore, an input feature of a model may be constructed based on the action feature, the image feature, and an audio feature of audio content. Additionally, the input feature may be provided to the model to determine a matching degree between the video content and the audio content.

Based on this method, the embodiments of the present disclosure can comprehensively consider the matching degree between the action feature of the video content and the audio feature and the matching degree between the image feature of the video content and the audio feature. Thus, the obtained matching degree between the video content and the audio content can include not only a matching degree in overall audio and image content, but also a matching degree in audio and image rhythm. Therefore, the accuracy of the matching degree between the video content and the audio content can be evaluated.

Accordingly, the embodiments of the present disclosure can evaluate the matching degree between the video content and the audio content from multiple perspectives based on images and actions of the video content and the audio content, thereby improving the accuracy of the matching degree between the video content and the audio content.

Various example implementations of the solution are described in detail below in further conjunction with the drawings.

### Example Environment

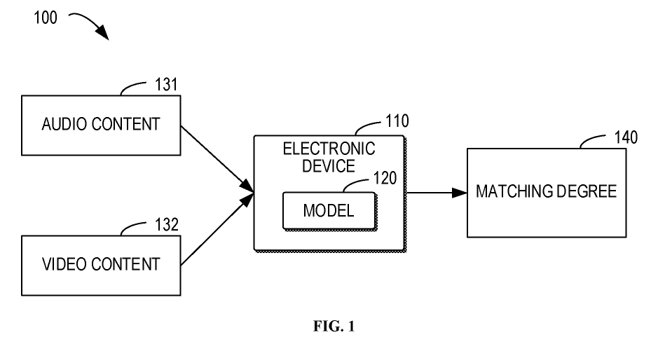

FIG. 1 shows a schematic diagram of an example environment 100 in which the embodiments of the present disclosure can be implemented. In the example environment 100, an electronic device 110 may support invoking a model 120. The model 120 may be deployed in the electronic device 110, or may be deployed in other electronic devices and support the invoking from the electronic device 110. The electronic device 110 may use the model 120 to process audio content 131 and video content 132, and thus obtain a matching degree 140 between the audio content 131 and the video content 132.

The electronic device 110 may include any computing system with computing power, such as various computing devices/systems, terminal devices, and server devices. The terminal device may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (Personal Communication System, PCS) device, a personal navigation device, a personal digital assistant (Personal Digital Assistant, PDA), an audio/video player, a digital camera/video camera, a positioning device, a television receiver, a radio broadcast receiver, an e-book device, a game device, or any combination of the foregoing, including the fittings and peripherals of these devices or any combination thereof. In some embodiments, the terminal device can also support any type of user-specific interface (such as "wearable" circuitry, etc.).

The server device may be an independent physical server, a server cluster or distributed system composed of multiple physical servers, or a cloud server providing cloud services, cloud databases, cloud computing, cloud functions, cloud storage, network services, cloud communications, middleware services, domain name services, security services, content delivery networks, and basic cloud computing services such as big data and artificial intelligence platforms. The server device may include, for example, a computing system/server, such as a mainframe, an edge computing node, a computing device in a cloud environment, and so on. The server device may support the electronic device 110 to invoke the model 120.

A communication connection may be established between the server device and the terminal device. The communication connection may be established by wired or wireless means. The communication connection may include, but is not limited to, a Bluetooth connection, a mobile network connection, a universal serial bus (Universal Serial Bus, USB) connection, a wireless fidelity (Wireless Fidelity, WiFi) connection, etc., and the embodiments of the present disclosure are not limited in this regard. In the embodiments of the present disclosure, the server device and the terminal device may implement signaling interaction through the communication connection between the two.

It would be appreciated that the structure and function of each element in the environment 100 are described for purposes of example only, without suggesting any limitation to the scope of the present disclosure.

Some example embodiments of the present disclosure will be described below with continued reference to the drawings.

### Example Process of Evaluating a Matching Degree

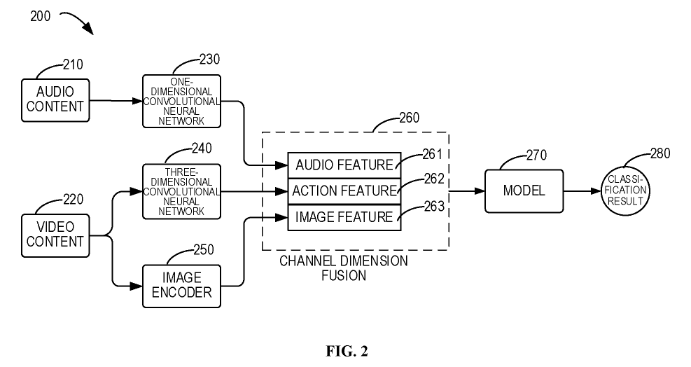

Some example processes of evaluating a matching degree between audio content and video content according to the embodiments of the present disclosure are described below with reference to FIG. 2. FIG. 2 shows a schematic diagram of an example process of evaluating a matching degree between audio content and video content according to some embodiments of the present disclosure. The process 200 may be provided, for example, by the electronic device 110 shown in FIG. 1.

In some embodiments, the electronic device 110 may acquire audio content and video content to be matched. As an example, the audio content and video content to be matched may have the same duration, and thus may be encoded as corresponding features with the number of channels, thereby improving the matching accuracy. As an example, the audio content and video content to be matched may be uploaded by a user, or may be stored locally on the electronic device 110 or stored in the cloud. As an example, the electronic device 110 may batch-evaluate the matching degrees corresponding to multiple audio-video pairs (the audio-video pair is also referred to as a combination pair of audio content and video content). In the embodiments of the present disclosure, the evaluation of the matching degree between one piece of audio content and one piece of video content is taken as an example, and for the specific implementation of batch-evaluation, reference may be made to the embodiments of the present disclosure.

According to the process 200 shown in FIG. 2, the solution for evaluating the matching degree between the audio content and the video content provided by the embodiments of the present disclosure is described for purposes of example below by taking the electronic device 110 matching the audio content 210 and the video content 220 as an example.

In some embodiments, the electronic device 110 may determine an audio feature 261 (also referred to as an audio representation) of the audio content 210. As an example, the audio feature 261 may be implemented by an appropriate audio feature determination tool, such as some neural network models that may determine the audio feature 261. As an example, the electronic device 110 may input the audio content 210 into an attention mechanism neural network model to obtain the audio feature 261.

In order to improve the accuracy of determining the audio feature 261, the electronic device 110 may first determine the Mel spectrogram of the audio content 210, and encode the Mel spectrogram to obtain the audio feature 261 of the audio content 210. As an example, the electronic device 110 may first use a Mel spectrogram determination tool to determine the Mel spectrogram (for example, a tensor with the dimension of [T1, D1]) of the audio content 210. Furthermore, the electronic device 110 may input the Mel spectrogram of the audio content 210 into an audio encoder (for example, a one-dimensional convolutional neural network 230) to obtain the audio feature 261 of the audio content 210. It would be appreciated that the electronic device 110 may also use other audio feature 261 determination tools to determine the audio feature 261 of the audio content 210, and the embodiments of the present disclosure are not intended to limit the specific implementation of the determination of such audio features.

In some embodiments, the audio feature 261 may be inconsistent with the video length of the video content 220, which in turn leads to low accuracy in evaluating the matching degree between the audio content and the video content. Therefore, the electronic device 110 may add network layers such as a downsampling neural network layer and a pooling layer to the audio feature determination tool to adjust the dimension of the audio feature 261. As an example, based on the added network layers such as the downsampling neural network layer and the pooling layer, the electronic device 110 may obtain the audio feature 261 with a reduced dimension. As an example, the dimension of the audio feature 261 may be [T2, D2], and T1 may be multiple times T2 (for example, 4 times, 8 times, etc.).

Furthermore, the electronic device 110 may determine the video content feature of the video content 220 for evaluating the matching degree between the audio content 210 and the video content 220. As an example, the electronic device 110 may determine the video tensor of the specified dimension (for example, the dimension [8,224,224,3], etc., and such specified dimension may be adjusted according to the actual situation) corresponding to the video content 220, so as to improve the degree of adaptation between the embodiments of the present disclosure and various common video content sources.

As an example, the electronic device 110 may adjust the video attribute (for example, at least one of resolution and a frame rate) of the video content 220, and then acquire the video tensor that corresponds to the video content 220 and satisfies the pre-determined video attribute. For example, the pre-determined video attribute may be the specified dimension, and the specified dimension may indicate the number of frames of the video content, the width of the video content, the height of the video content, and/or the number of channels of the video frame. For example, the specified dimension [8,224,224,3] may indicate the video content with the video frame rate of 8, the video resolution of [224,224], the video height of 224, and the number of image channels of 3. Based on the specified dimension, the information processing solution provided by the embodiments of the present disclosure may have higher compatibility.

Furthermore, the electronic device 110 may separately determine the action feature 262 (also referred to as action representation) and the image feature 263 (also referred to as image representation) corresponding to the video tensor. Therefore, the electronic device 110 may construct an input feature of the model 270 based on the audio feature 261, the action feature 262, and the image feature 263, and then use the model 270 to determine the matching degree between the audio content 210 and the video content 220. As an example, the action feature 262 and the image feature 263 may contain different types of information in the video content. For example, the action feature may include information corresponding to transient sound effects in the video content, and the image feature may include image information of each video frame in the video content. As an example, the model 270 may include any appropriate model (for example, the model 140), which may output the classification result 280 indicating the matching degree between the corresponding audio content and video content based on the received fusion feature 260, for example.

As an example, the action feature 262 and the image feature 263 may be determined and obtained using different video feature determination tools. As an example, the action feature 262 may be determined by processing using an action encoder (for example, a three-dimensional convolutional neural network 240). Specifically, the electronic device 110 may use the action encoder to compare the image information of each video frame of the video content 220 with the image information of the corresponding adjacent video frame, and then determine the image action information corresponding to each video frame. As an example, the adjacent video frame corresponding to one of the video frames of the video content 220 may be a video frame before the video frame and/or a video frame after the video frame. Furthermore, the electronic device 110 may use the action encoder to encode the image action information corresponding to each video frame to determine the action feature 262. Therefore, the electronic device 110 may capture the information corresponding to the transient sound effect in the video content 220.

As an example, the image feature 263 may be determined by processing using an image encoder 250. Specifically, the electronic device 110 may use the image encoder 250 to process each video frame of the video content 220 to determine the image information of each video frame, and then encode the image information of each video frame to determine the image feature of the video content 220. As an example, the electronic device 110 may input the video tensor of the video content 220 into the image encoder 250, and the image encoder 250 may be configured to encode the input video tensor, thereby obtaining the image feature 263 containing the global image information of each video frame. As an example, the image encoder 250 may be any suitable image encoder, and the present disclosure is not intended to limit the specific structure of the image encoder.

It would be appreciated that the action feature 262 and the image feature 263 may also be implemented by other video feature determination models, such as a pre-trained Transformer model, etc. The embodiments of the present disclosure are not intended to limit the specific video feature determination tool used for video feature determination.

In some embodiments, the electronic device 110 may determine the matching degree between the audio content 210 and the video content 220 by calculating the vector distance between the audio feature 261 and the action feature 262 (and/or the image feature 263). The accuracy of such a matching degree evaluation scheme is relatively low. Therefore, in the embodiments of the present disclosure, the electronic device 110 fuses the audio feature 261, the action feature 262, and the image feature 263 to obtain the input feature (for example, the fusion feature 260) of the model. As an example, the electronic device 110 may fuse the audio feature 261, the action feature 262, and the image feature 263 in the channel dimension. For example, the audio feature 261, the action feature 262, and the image feature 263 per second are concatenated (or fused in other fusion methods) into the fusion feature 260 corresponding to the second.

Furthermore, the electronic device 110 may use the model 270 to classify the fusion feature 260 to obtain the classification result 280. As an example, the classification result 280 may indicate the matching degree between the audio content 210 and the video content 220. As an example, the electronic device 110 may determine the classification result 280 from multiple candidate classifications corresponding to different matching degrees. Therefore, the electronic device 110 may determine the matching degree between the video content 220 and the audio content 210 based on the classification result 280.

In some embodiments, the electronic device 110 may adjust the range of the classification result 280 based on the sound effect type of the audio content 210. For example, if the sound effect type of the audio content 210 is an environmental sound effect type (for example, the audio content 210 is audio containing environmental sound effects), the electronic device 110 may determine the classification result 280 from a first candidate classification and a second candidate classification. If the sound effect type of the audio content is a transient sound effect type (for example, the audio content 210 is audio containing transient sound effects), the electronic device 110 may determine the classification result 280 from the first candidate classification, the second candidate classification, and a third candidate classification. As an example, different matching degrees corresponding to the first candidate classification, the second candidate classification and the third candidate classification indicate the matching situation between the audio content 210 and the video content 220 at least in terms of semantics and rhythm.

As an example, a first matching degree corresponding to the first candidate classification (for example, marked as 2, or other suitable identification) indicates that the video semantics of the video content matches the audio semantics of the audio content, and the video rhythm of the video content matches the audio rhythm of the audio content; a second matching degree corresponding to the second candidate classification (for example, marked as 0, or other suitable identification) indicates that the video semantics of the video content mismatches the audio semantics of the audio content, and the video rhythm of the video content mismatches the audio rhythm of the audio content; a third matching degree corresponding to the third candidate classification (for example, marked as 1, or other suitable identification) indicates that the video semantics of the video content matches the audio semantics of the audio content, but the video rhythm of the video content mismatch the audio rhythm of the audio content. Therefore, the electronic device 110 may further improve the accuracy of the classification result 280, thereby further improving the accuracy of evaluating the matching degree between the audio content 210 and the video content 220.

In order to improve the accuracy of the classification result 280, the electronic device 110 may use a sample set to pre-train the model 270. As an example, the sample set may include a reference sample video and a set of extended sample videos generated based on the reference sample video. The set of extended sample videos may be generated by sample enhancement such as video content cropping, video content flipping, video content rotation, video content shading, and frame dropping on the reference sample video. Specifically, the set of extended sample videos may be generated based on at least one of the following sample enhancement processes: cropping at least part of the reference sample video; flipping at least part of the reference sample video; rotating at least part of the reference sample video; adjusting the brightness of the reference sample video; deleting at least part of video frames of the reference sample video. Therefore, the embodiments of the present disclosure may improve the generalization ability of the model 270 for various scenarios, thereby improving the accuracy of the classification result 280.

In some embodiments, the model 270 may further include a model with a rotary position encoding layer, and the electronic device 110 may use the rotary position encoding layer to process the input feature to determine the matching degree between the audio content 210 and the video content 220. Based on the rotary position encoding layer, the model 270 may process input features of various lengths, thereby improving the generalization ability of the model 270 for various audio content and video content to be matched.

In some embodiments, the electronic device 110 may further perform content filtering on the audio content 210 to improve the accuracy of the audio feature, thereby improving the accuracy of the classification result 280. As an example, the electronic device 210 may eliminate the audio content segment with music, semantics, etc., in the audio content 210 based on the audio content of the audio content 210, so as to improve the proportion of sound effect content in the audio content 210.

In some embodiments, the information processing solution may be used to construct training data of an audio generation model, thereby improving the quality of the trained audio generation model. Specifically, the electronic device 110 may evaluate the matching degree between multiple pairs of audio content and video content by the solution of evaluating the matching degree between the audio content and the video content. Furthermore, the electronic device 110 may use the audio content and video content whose matching degree meets the pre-determined matching degree to construct the training data, so as to train the audio generation model based on the training data. As an example, the electronic device 110 may add the training data to the training dataset, and perform audio content and video content based on the training dataset to further improve the quality of the audio generation model. Based on this, the electronic device 110 may obtain the audio generation model with higher audio generation quality, and therefore, the electronic device 110 may use the audio generation model to generate audio that matches the video better.

Based on this method, the embodiments of the present disclosure can comprehensively consider the matching degree between the action feature of the video content and the audio feature and the matching degree between the image feature of the video content and the audio feature. Thus, the obtained matching degree between the video content and the audio content can include not only a matching degree in overall audio-video content, but also a matching degree in audio-video rhythm. Therefore, the accuracy of the matching degree between the video content and the audio content can be evaluated.

Accordingly, the embodiments of the present disclosure can evaluate the matching degree between the video content and the audio content from multiple perspectives based on images and actions of the video content and the audio content, thereby improving the accuracy of the matching degree between the video content and the audio content.

### Example Process

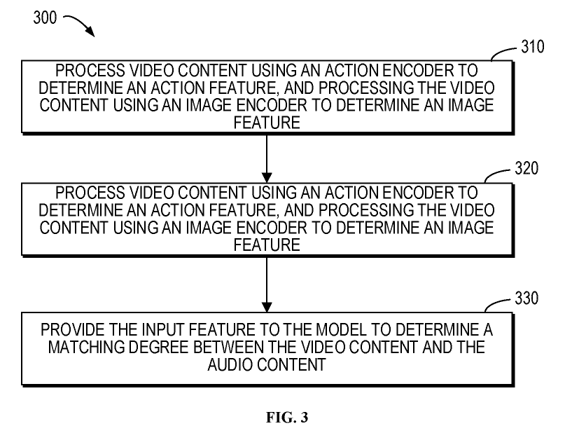

FIG. 3 shows a flowchart of an example process 300 of information processing according to some embodiments of the present disclosure. The process 300 may be implemented at the electronic device 110. The process 300 is described below with reference to FIG. 1.

As shown in FIG. 3, at a block 310, the electronic device 110 processes video content using an action encoder to determine an action feature, and processes the video content using an image encoder to determine an image feature.

At a block 320, the electronic device 110 constructs an input feature of a model based on the action feature, the image feature, and an audio feature of audio content.

At a block 330, the electronic device 110 provides the input feature to the model to determine a matching degree between the video content and the audio content.

In some embodiments, processing the video content using the action encoder to determine the action feature includes: comparing, using the action encoder, image information of each video frame of the video content with image information of a corresponding adjacent video frame to determine image action information corresponding to each video frame; and determining the action feature based on the image action information corresponding to each video frame.

In some embodiments, processing the video content using the image encoder to determine the image feature includes: processing each video frame of the video content using the image encoder to determine image information of each video frame; and determining the image feature by encoding the image information of each video frame.

In some embodiments, the audio feature of the audio content is determined based on the following process: determining a Mel spectrogram of the audio content; and encoding the Mel spectrogram using an audio encoder to determine the audio feature.

In some embodiments, the action feature, the image feature, and the audio feature correspond to the same multiple feature channels, and constructing the input feature of the model based on the action feature, the image feature, and the audio feature includes: fusing the action feature, the image feature, and the audio feature based on the multiple feature channels to construct the input feature of the model.

In some embodiments, before processing the video content using the action encoder, the process 300 further includes: adjusting a video attribute of the video content to satisfy a pre-determined video attribute, where the video attribute includes at least one of resolution and a frame rate.

In some embodiments, providing the input feature to the model to determine the matching degree between the video content and the audio content includes: providing the input feature to the model to determine a classification result for the input feature, where the classification result is determined from multiple candidate classifications corresponding to different matching degrees; and determining the matching degree between the video content and the audio content based on the classification result.

In some embodiments, determining the classification result includes: in response to a sound effect type of the audio content being an environmental sound effect type, determining the classification result from a first candidate classification and a second candidate classification; or in response to a sound effect type of the audio content being a transient sound effect type, determining the classification result from a first candidate classification, a second candidate classification, and a third candidate classification.

In some embodiments, a first matching degree corresponding to the first candidate classification indicates that video semantics of the video content matches audio semantics of the audio content, and a video rhythm of the video content matches an audio rhythm of the audio content; a second matching degree corresponding to the second candidate classification indicates that the video semantics of the video content mismatches the audio semantics of the audio content, and the video rhythm of the video content mismatches the audio rhythm of the audio content; a third matching degree corresponding to the third candidate classification indicates that the video semantics of the video content matches the audio semantics of the audio content, but the video rhythm of the video content mismatches the audio rhythm of the audio content.

In some embodiments, the model uses a rotary position encoding layer to process the input feature to determine the matching degree, the rotary position encoding layer being configured to encode input features of different lengths.

In some embodiments, the model is trained based on a sample set, the sample set including a reference sample video and a set of extended sample videos generated based on the reference sample video.

In some embodiments, the set of extended sample videos is generated based on at least one of the following sample enhancement processes: cropping at least part of the reference sample video; flipping at least part of the reference sample video; rotating at least part of the reference sample video; adjusting the brightness of the reference sample video; deleting at least part of video frames of the reference sample video.

In some embodiments, the process 300 further includes: constructing, in response to the matching degree between the video content and the audio content satisfying a pre-determined matching degree, training data based on the video content and the audio content to add the training data to a training dataset; and training an audio generation model using the training dataset, where the audio generation model is configured to generate audio matching the video.

### Example Apparatus and Device

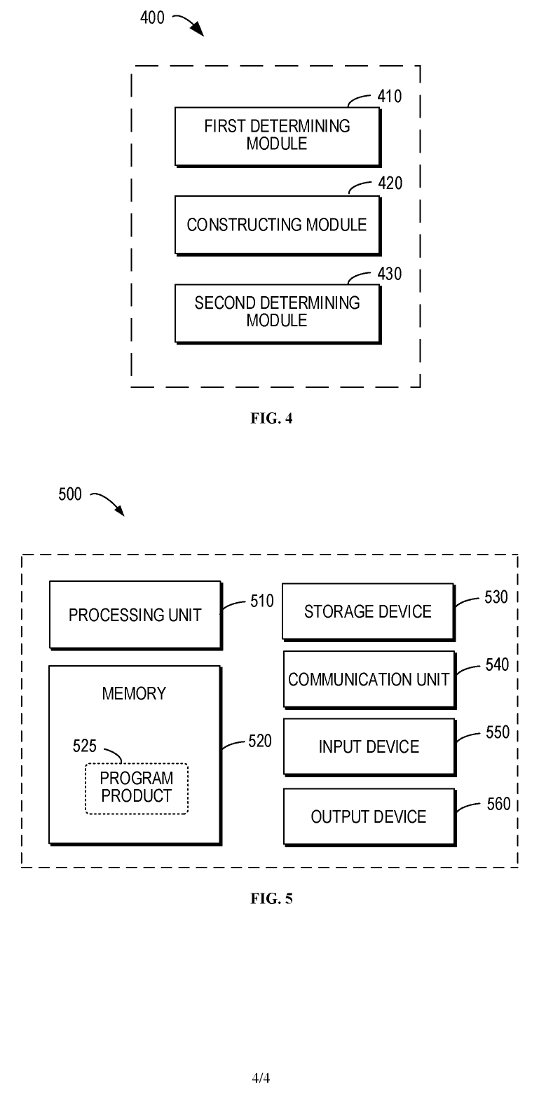

The embodiments of the present disclosure further provide a corresponding apparatus for implementing the above methods or processes. FIG. 4 shows a schematic structural block diagram of an example apparatus 400 for information processing according to some embodiments of the present disclosure. The apparatus 400 may be implemented as or included in the electronic device 110. Each module/component in the apparatus 400 may be implemented by hardware, software, firmware, or any combination thereof.

As shown in FIG. 4, the apparatus 400 includes a first determining module 410 configured to process video content using an action encoder to determine an action feature, and process the video content using an image encoder to determine an image feature; a constructing module 420 configured to construct an input feature of a model based on the action feature, the image feature, and an audio feature of audio content; and a second determining module 430 configured to provide the input feature to the model to determine a matching degree between the video content and the audio content.

In some embodiments, the first determining module 410 is further configured to: compare, using the action encoder, image information of each video frame of the video content with image information of a corresponding adjacent video frame to determine image action information corresponding to each video frame; and determine the action feature based on the image action information corresponding to each video frame.

In some embodiments, the first determining module 410 is further configured to: process each video frame of the video content using the image encoder to determine image information of each video frame; and determine the image feature by encoding the image information of each video frame.

In some embodiments, the apparatus 400 further includes a third determining module configured to: determine a Mel spectrogram of the audio content; and encode the Mel spectrogram using an audio encoder to determine the audio feature.

In some embodiments, the action feature, the image feature, and the audio feature correspond to the same multiple feature channels, and the constructing module 420 is further configured to: fuse the action feature, the image feature, and the audio feature based on the multiple feature channels to construct the input feature of the model.

In some embodiments, the apparatus 400 further includes an adjusting module configured to: adjust a video attribute of the video content to satisfy a pre-determined video attribute, where the video attribute includes at least one of resolution and a frame rate.

In some embodiments, the second determining module 430 is further configured to: provide the input feature to the model to determine a classification result for the input feature, where the classification result is determined from multiple candidate classifications corresponding to different matching degrees; and determine the matching degree between the video content and the audio content based on the classification result.

In some embodiments, the second determining module 430 is further configured to: in response to a sound effect type of the audio content being an environmental sound effect type, determine the classification result from a first candidate classification and a second candidate classification; or in response to a sound effect type of the audio content being a transient sound effect type, determine the classification result from a first candidate classification, a second candidate classification, and a third candidate classification.

In some embodiments, a first matching degree corresponding to the first candidate classification indicates that video semantics of the video content matches audio semantics of the audio content, and a video rhythm of the video content matches an audio rhythm of the audio content; a second matching degree corresponding to the second candidate classification indicates that the video semantics of the video content mismatches the audio semantics of the audio content, and the video rhythm of the video content mismatches the audio rhythm of the audio content; a third matching degree corresponding to the third candidate classification indicates that the video semantics of the video content matches the audio semantics of the audio content, but the video rhythm of the video content mismatches the audio rhythm of the audio content.

In some embodiments, the model uses a rotary position encoding layer to process the input feature to determine the matching degree, the rotary position encoding layer being configured to encode input features of different lengths.

In some embodiments, the model is trained based on a sample set, the sample set including a reference sample video and a set of extended sample videos generated based on the reference sample video.

In some embodiments, the set of extended sample videos is generated based on at least one of the following sample enhancement processes: cropping at least part of the reference sample video; flipping at least part of the reference sample video; rotating at least part of the reference sample video; adjusting the brightness of the reference sample video; deleting at least part of video frames of the reference sample video.

In some embodiments, the apparatus 400 further includes a training module configured to: construct, in response to the matching degree between the video content and the audio content satisfying a pre-determined matching degree, training data based on the video content and the audio content to add the training data to a training dataset; and train an audio generation model using the training dataset, where the audio generation model is configured to generate audio matching the video.

The modules included in the apparatus 400 may be implemented in various ways, including software, hardware, firmware, or any combination thereof. In some embodiments, one or more units may be implemented using software and/or firmware, such as machine executable instructions stored on a medium. In addition to machine executable instructions or as an alternative, some or all modules in the apparatus 400 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), etc.

FIG. 5 shows a block diagram of an electronic device 500 in which one or more embodiments of the present disclosure may be implemented. It would be appreciated that the electronic device 500 shown in FIG. 5 is only for purposes of example and should not constitute any limitation on the functionality and scope of the embodiments described herein. The electronic device 500 shown in FIG. 5 may be used to implement the electronic device 110 in FIG. 1 or the apparatus 400 in FIG. 4.

As shown in FIG. 5, the electronic device 500 is in the form of a general electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and may perform various processing based on the programs stored in the memory 520. In a multiprocessor system, multiple processing units execute computer executable instructions in parallel to improve the parallel processing capability of the electronic device 500.

The electronic device 500 typically includes multiple computer storage medium. Such medium may be any available medium that is accessible to the electronic device 500, including but not limited to volatile and non-volatile medium, removable and non-removable medium. The memory 520 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine-readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk drive for reading from or writing to a removable, non-volatile disk (such as a "floppy disk"), and an optical disk drive for reading from or writing to a removable, non-volatile optical disk may be provided. In these cases, each drive may be connected to the bus (not shown) by one or more data medium interfaces. The memory 520 may include a computer program product 525 having one or more program modules configured to perform various methods or acts of the various embodiments of the present disclosure.

The communication unit 540 enables communication with other electronic devices via the communication medium. Additionally, the functions of the components of the electronic device 500 may be implemented by a single computing cluster or multiple computing machines, and the multiple computing machines may communicate by communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may also communicate with one or more external devices (not shown) such as a storage device, a display device, etc., with one or more devices that enable the user to interact with the electronic device 500, or with any devices (such as a network card, a modem, etc.) that enable the electronic device 500 to communicate with one or more other electronic devices via the communication unit 540 as needed. Such communication may be performed via input/output (I/O) interfaces (not shown).

According to an example implementation of the present disclosure, there is provided a computer-readable storage medium having computer executable instructions stored thereon, where the computer executable instructions are executed by a processor to implement the method described above. According to an example implementation of the present disclosure, there is further provided a computer program product tangibly stored on a non-transitory computer-readable medium and including computer executable instructions, where the computer executable instructions are executed by a processor to implement the method described above.

Various aspects of the present disclosure are described herein with reference to the flowcharts and/or block diagrams of the method, apparatus, device and computer program product implemented according to the present disclosure. It would be appreciated that each block of the flowcharts and/or block diagrams, and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, such that when the instructions are executed by the processing unit of the computer or other programmable data processing apparatus, an apparatus for implementing the functions/actions specified in one or more blocks of the flowcharts and/or block diagrams is produced. These computer-readable program instructions may also be stored in a computer-readable storage medium, and these instructions cause the computer, programmable data processing apparatus and/or other devices to work in a specific manner. Thus, the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, other programmable data processing apparatus, or other devices, so that a series of operating steps are performed on the computer, other programmable data processing apparatus, or other devices to generate a computer-implemented process. Thus, the instructions executed on the computer, other programmable data processing apparatus, or other devices implement the functions/actions specified in one or more blocks of the flowcharts and/or block diagrams.

The flowchart and block diagrams in the drawings show the possibly implemented architectures, functions and operations of the system, method and computer program product according to multiple implementations of the present disclosure. In this regard, each block in the flowchart or block diagram may represent a module, program segment or part of instructions, and the module, program segment or part of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform specified functions or actions, or may be implemented by a combination of special-purpose hardware and computer instructions.

The implementations of the present disclosure have been described above, and the above description is for purposes of example, non-exhaustive, and not limited to the disclosed implementations. Without departing from the scope and spirit of the illustrated implementations, many modifications and changes will be apparent to those of ordinary skill in the art. The choice of terms used herein is intended to best explain the principles of the implementations, practical applications, or improvements to the technologies in the market, or to enable other ordinary skilled persons in the art to understand the implementations disclosed herein.

What is claimed is:

1. A method of information processing, comprising:
processing video content using an action encoder to determine an action feature, and processing the video content using an image encoder to determine an image feature;
constructing an input feature of a model based on the action feature, the image feature, and an audio feature of audio content; and
providing the input feature to the model to determine a matching degree between the video content and the audio content.

2. The method of claim 1, wherein processing the video content using the action encoder to determine the action feature comprises:
comparing, using the action encoder, image information of each video frame of the video content with image information of a corresponding adjacent video frame to determine image action information corresponding to each video frame; and
determining the action feature based on the image action information corresponding to each video frame.

3. The method of claim 1, wherein processing the video content using the image encoder to determine the image feature comprises:
processing each video frame of the video content using the image encoder to determine image information of each video frame; and
determining the image feature by encoding the image information of each video frame.

4. The method of claim 1, wherein the audio feature of the audio content is determined based on the following process:
determining a Mel spectrogram of the audio content; and
encoding the Mel spectrogram using an audio encoder to determine the audio feature.

5. The method of claim 1, wherein the action feature, the image feature, and the audio feature correspond to a plurality of same feature channels, and constructing the input feature of the model based on the action feature, the image feature, and the audio feature comprises:
fusing the action feature, the image feature, and the audio feature based on the plurality of feature channels to construct the input feature of the model.

6. The method of claim 1, wherein before processing the video content using the action encoder, the method further comprises:
adjusting a video attribute of the video content to satisfy a pre-determined video attribute, wherein the video attribute comprises at least one of resolution and a frame rate.

7. The method of claim 1, wherein providing the input feature to the model to determine the matching degree between the video content and the audio content comprises:
providing the input feature to the model to determine a classification result for the input feature, wherein the classification result is determined from a plurality of candidate classifications corresponding to different matching degrees; and
determining the matching degree between the video content and the audio content based on the classification result.

8. The method of claim 7, wherein determining the classification result comprises:
determining, in response to a sound effect type of the audio content being an environmental sound effect type, the classification result from a first candidate classification and a second candidate classification; or
determining, in response to a sound effect type of the audio content being a transient sound effect type, the classification result from a first candidate classification, a second candidate classification, and a third candidate classification.

9. The method of claim 8, wherein:
a first matching degree corresponding to the first candidate classification indicates that video semantics of the video content matches audio semantics of the audio content, and a video rhythm of the video content matches an audio rhythm of the audio content,
a second matching degree corresponding to the second candidate classification indicates that the video semantics of the video content mismatches the audio semantics of the audio content, and the video rhythm of the video content mismatches the audio rhythm of the audio content, and
a third matching degree corresponding to the third candidate classification indicates that the video semantics of the video content matches the audio semantics of the audio content, but the video rhythm of the video content mismatches the audio rhythm of the audio content.

10. The method of claim 1, wherein the model uses a rotary position encoding layer to process the input feature to determine the matching degree, the rotary position encoding layer being configured to encode input features of different lengths.

11. The method of claim 1, wherein the model is trained based on a sample set, the sample set comprising a reference sample video and a set of extended sample videos generated based on the reference sample video.

12. The method of claim 11, wherein the set of extended sample videos is generated based on at least one of the following sample enhancement processes:
cropping at least part of the reference sample video;
flipping at least part of the reference sample video;
rotating at least part of the reference sample video;
adjusting brightness of the reference sample video;
deleting at least part of video frames of the reference sample video.

13. The method of claim 1, further comprising:
constructing, in response to the matching degree between the video content and the audio content satisfying a pre-determined matching degree, training data based on the video content and the audio content to add the training data to a training dataset; and
training an audio generation model using the training dataset, wherein the audio generation model is configured to generate audio matching a video.

14. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
processing video content using an action encoder to determine an action feature, and processing the video content using an image encoder to determine an image feature;
constructing an input feature of a model based on the action feature, the image feature, and an audio feature of audio content; and
providing the input feature to the model to determine a matching degree between the video content and the audio content.

15. The electronic device of claim 14, wherein processing the video content using the action encoder to determine the action feature comprises:
comparing, using the action encoder, image information of each video frame of the video content with image information of a corresponding adjacent video frame to determine image action information corresponding to each video frame; and
determining the action feature based on the image action information corresponding to each video frame.

16. The electronic device of claim 14, wherein processing the video content using the image encoder to determine the image feature comprises:
processing each video frame of the video content using the image encoder to determine image information of each video frame; and
determining the image feature by encoding the image information of each video frame.

17. The electronic device of claim 14, wherein the audio feature of the audio content is determined based on the following process:
determining a Mel spectrogram of the audio content; and
encoding the Mel spectrogram using an audio encoder to determine the audio feature.

18. The electronic device of claim 14, wherein the action feature, the image feature, and the audio feature correspond to a plurality of same feature channels, and constructing the input feature of the model based on the action feature, the image feature, and the audio feature comprises:
fusing the action feature, the image feature, and the audio feature based on the plurality of feature channels to construct the input feature of the model.

19. The electronic device of claim 14, wherein before processing the video content using the action encoder, the acts further comprise:
adjusting a video attribute of the video content to satisfy a pre-determined video attribute, wherein the video attribute comprises at least one of resolution and a frame rate.

20. A non-transitory computer-readable storage medium having a computer program stored thereon, the computer program, when executed by a processor, implementing a method comprising:
processing video content using an action encoder to determine an action feature, and processing the video content using an image encoder to determine an image feature;
constructing an input feature of a model based on the action feature, the image feature, and an audio feature of audio content; and
providing the input feature to the model to determine a matching degree between the video content and the audio content.
